(19) United States
(12) Patent Application Publication
(10) Pub. No.: US 2002/0128076 A1
(43) Pub. Date: Sep. 12, 2002

(54) Method and apparatus to permit maintenance of tie bolt clamp load for extended temperature ranges

(75) Inventor: Daniel Lubell, Northridge, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Capstone Turbine Corporation, Chatsworth, CA (US)

(21) Appl. No.: 09/985,360

(22) Filed: Nov. 2, 2001

Related U.S. Application Data
(60) Provisional application No. 60/245,703, filed on Nov. 2, 2000.

(51) Int. Cl. F16D 3/00

(52) U.S. Cl. 464/107

(57) ABSTRACT

A system and method for maintaining an axial compression load associated with a tie bolt assembly. A tie bolt couples a compressor to a turbine. A sleeve is supported on the tie bolt. The tie bolt compresses the compressor and sleeve against the turbine during operation thereby causing an axial compressive force. At least a portion of the sleeve is made of a less thermally sensitive material such that during rotation of the tie bolt assembly, the sleeve resists deformation and maintains the axial compressive load.

### RELATED APPLICATIONS

This patent application claims the priority of provisional application serial No. 60/245,703, filed Nov. 2, 2000, which provisional application is incorporated by reference herein in its entirety.

### BACKGROUND OF THE INVENTION

1. Field of the Invention

The present invention relates generally to turbogenerators. More particularly, the invention relates to tie bolt systems and methods of their use in rotor shafts

2. Discussion of the Background

In a turbo generator system, a tie bolt is disposed between a compressor and turbine. The tie bolt is usually welded to the turbine wheel, or may extend through the turbine wheel.

A compressor sleeve is also disposed between the turbine and compressor. The compressor sleeve is located on the exterior surface of the tie bolt. The compressor sleeve is either coupled to thrust bearing disk or unitarily formed with the thrust bearing disk.

The tie bolt functions to press the thrust disk and compressor sleeve against the turbine wheel.

Most turbo generator components, including the tie bolt, compressor sleeve and thrust disk have been made of steel or steel alloys.

The present inventor recognized that, during operation, both the tie bolt and compressor sleeve absorb thermal energy and heat up. The present inventor recognized that such heating and centrigufal forces could change lengths of components resulting in mechanical instability. The present inventor recognized how to avoid such mechanical instabilities by suitable choice of materials and structures, to maintain loads on the rotating components providing mechanical stability. Specifically, the present inventor recognized the importance of and how to maintain an effective tie bolt load over an extended temperature range and rotational rate range.

### SUMMARY OF THE INVENTION

In one aspect, the invention provides a tie bolt clamping apparatus, comprising: a first component designed to rotate; a second component designed to rotate; a tie bolt coupled between said first component and said second component thereby forming a rotatable assembly in which said tie bolt, the first component, and the second component are constraint to rotate together; a shaft supported on said tie bolt and disposed between said first component and said second component; and wherein said tie bolt compresses said first shaft between said first component and said second component such that an axial compressive load on and first shaft is maintained during rotation of said rotatable assembly, thereby preventing mechanical instability.

In another aspect, the invention provides a tie bolt apparatus including a first component designed to rotate; a second component designed to rotate; a tie bolt coupled between said first component and said second component thereby forming a rotatable assembly in which the tie bolt, the first component, and the second component are constrained to rotate together about an axis defined by an elongated dimension of said tie bolt; a shaft coupled to at least one of said first component and said second component and supported on said tie bolt, said shaft having an interior surface and an exterior surface, said interior surface forming an inset along at least a portion of a length of at least one of said interior surface and said exterior surface; a clamp sleeve supported within said inset; and wherein said tie bolt presses said first sleeve and said clamp sleeve against said first component during rotation such that an axial compressive load on said shaft is maintained.

In yet another aspect, the invention provides a method for maintaining a compressive load associated with a rotor shaft, comprising the steps of: forming a rotational assembly including, a first component designed to rotate, a second component designed to rotate, a tie bolt coupled between said first component and said second component in which said tie bolt, said first component, and the second component are constrained to rotate together along an axis defined by an elongated dimension of said tie bolt, a shaft supported on said tie bolt, said shaft having at least one portion made of a material with a coefficient of thermal expansion which is lower than coefficients of thermal expansion of at least one of the material of said first component, said second component, and said tie bolt; and rotating said assembly such that said tie bolt compresses said shaft and said first component against said second component such that an axial compressive load is applied to said shaft, whereby said at least one portion minimally deforms and thereby maintains said axial compressive load.

Additional objects and advantages of the invention will be set forth in the following description, and in part will be evident from the description, or may be learned by practice of the invention. The objects and advantages of the invention may be realized and obtained by means of the instrumentalities and combinations particularly pointed out herein.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is perspective view, partially in section, of an integrated turbogenerator system;

FIG. 1B is a magnified perspective view, partially in section, of the motor/generator portion of the integrated turbogenerator of FIG. 1A;

FIG. 1C is an end view, from the motor/generator end, of the integrated turbogenerator of FIG. 1A;

FIG. 1D is a magnified perspective view, partially in section, of the combustor-turbine exhaust portion of the integrated turbogenerator of FIG. 1A;

FIG. 1E is a magnified perspective view, partially in section, of the compressor-turbine portion of the integrated turbogenerator of FIG. 1A;

FIG. 2 is a block diagram schematic of a turbogenerator system including a power controller having decoupled rotor speed, operating temperature, and DC bus voltage control loops;

FIG. 3A is a sectional view of a tie bolt clamp system of the present invention in a plane defined by the axis of the tie bolt;

FIG. 3B is a cross-sectional view of the tie bolt clamp system of FIG. 3A taken along line B-B.

FIG. 3C is a magnified sectional view of the portion of the sleeve of FIG. 3A containing an end of a clamp sleeve; and

FIG. 4 is a sectional view of an alternate embodiment of the tie bolt clamp system of the present invention including a plate.

### DETAILED DESCRIPTION OF THE PREFERRED EMBODIMENTS

The present invention provides a novel systems and methods for maintaining in a rotor shaft a tiebolt clamp load for extended temperature ranges, and to maintain the axial compressive load that develops in a rotor shaft.

Referring now to the drawings, like reference numerals designate identical or corresponding parts throughout the several views.

Mechanical Structural Embodiment of a Turbogenerator

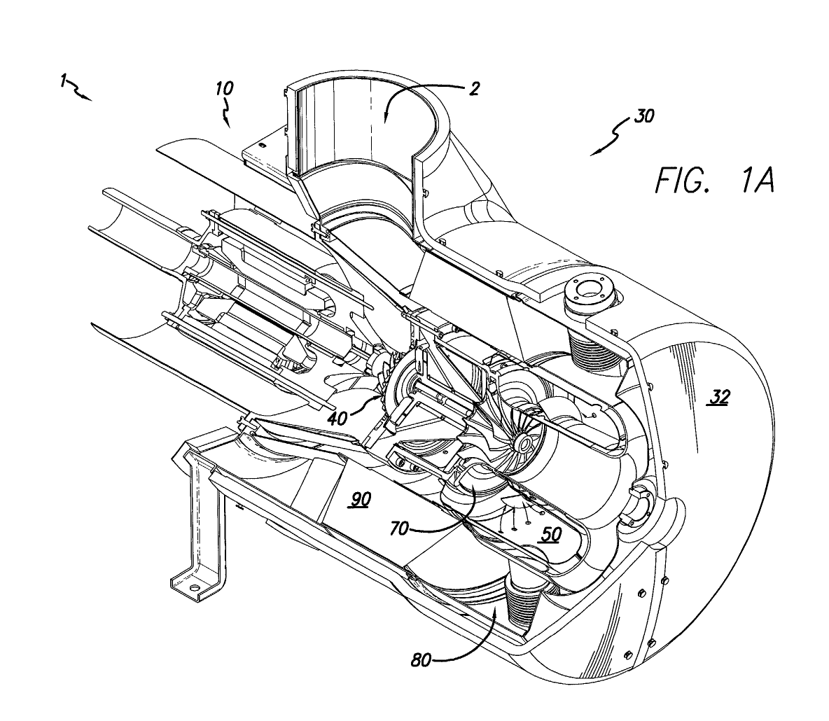

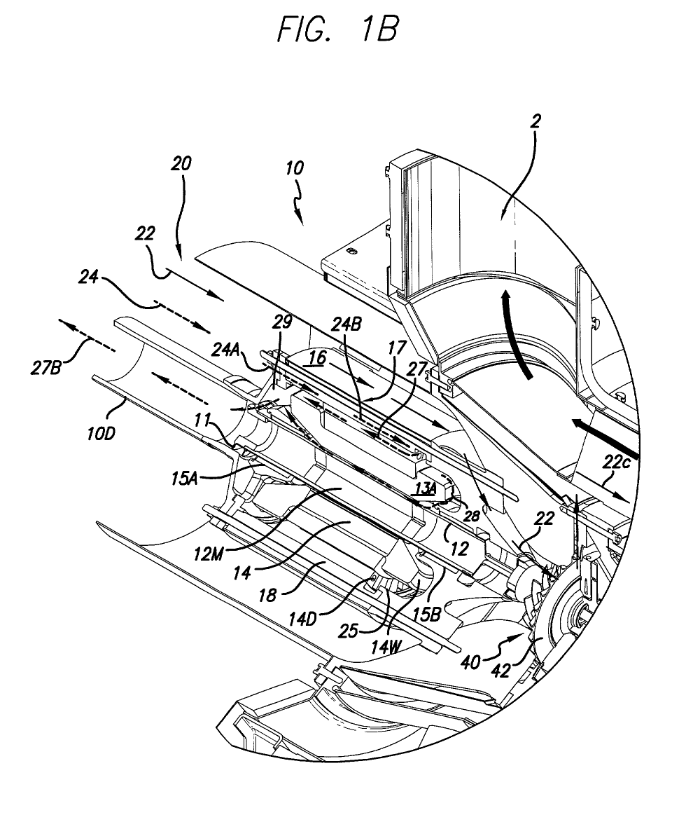

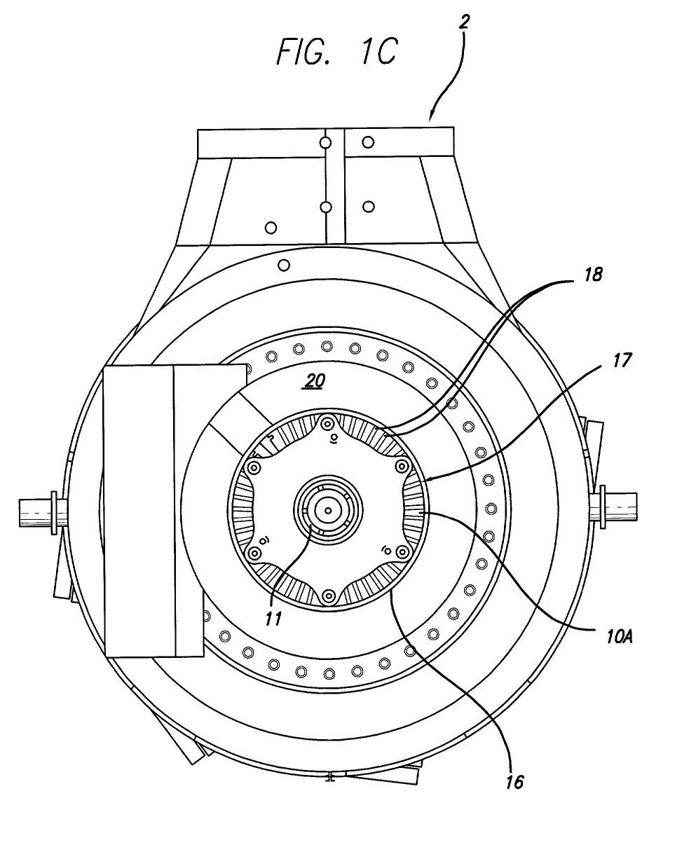

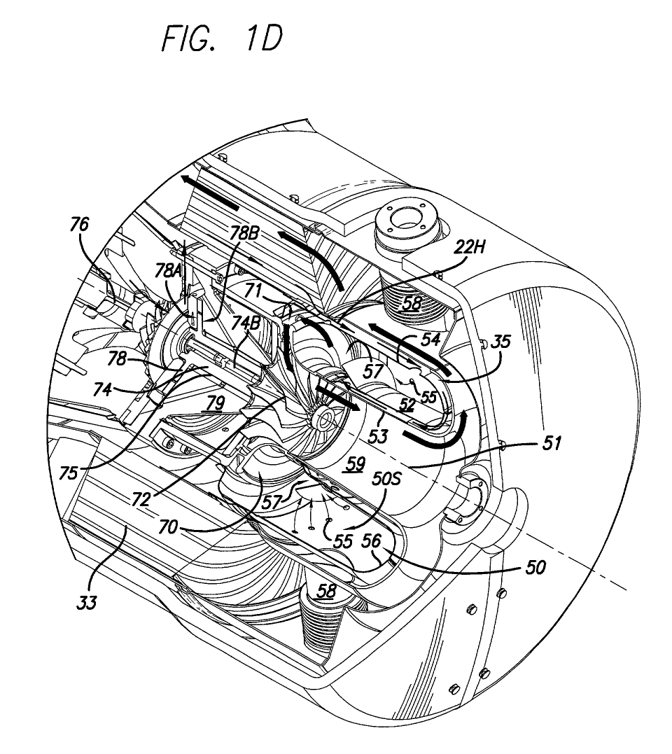

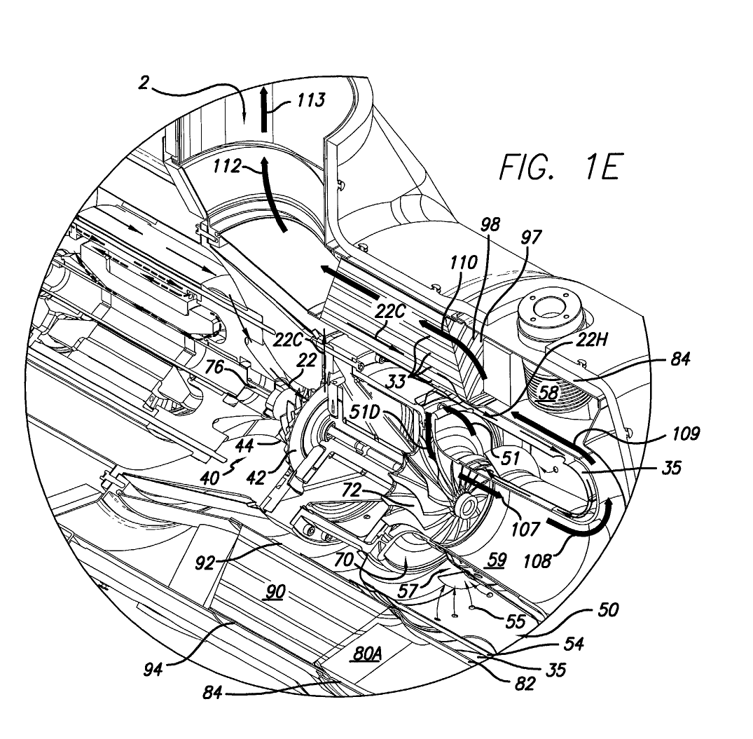

With reference to FIG. 1A, an integrated turbogenerator 1 according to the present invention generally includes motor/generator section 10 and compressor-combustor section 30. Compressor-combustor section 30 includes exterior can 32, compressor 40, combustor 50 and turbine 70. A recuperator 90 may be optionally included.

Referring now to FIG. 1B and FIG. 1C, in a currently preferred embodiment of the present invention, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

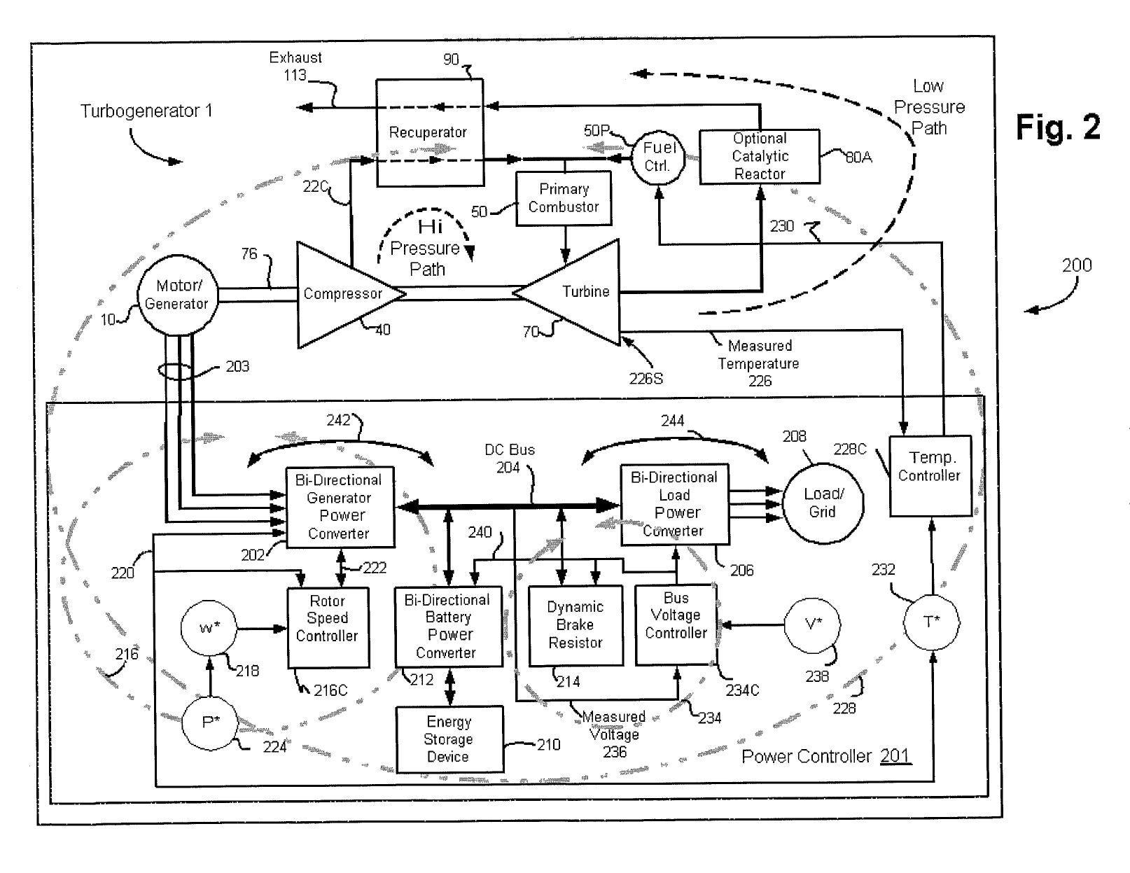

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 51. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 76 is rotatably supported preferably by a bilateral thrust bearing 78A and 78B. Journal or radial bearing 75 and thrust bearings 78A and 78B may be fluid film or foil bearings.

Turbine wheel 72, Bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 98 of recuperator 90, as indicated by gas flow arrows 108 and 109 respectively.

In an alternate embodiment of the present invention, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

Alternative Use of the Invention Other Than in Integrated Turbogenerators

An integrated turbogenerator is a turbogenerator in which the turbine, compressor, and generator are all constrained to rotate based upon rotation of the shaft to which the turbine is connected. The invention disclosed herein is preferably but not necessarily used in connection with a turbogenerator, and preferably but not necessarily used in connection with an integrated turbogenerator.

Turbogenerator System Including Controls

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U. S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bidirectional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bidirectional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bidirectional arrow 242, and controls bus voltage to a set point by (1) applying or removing power from DC bus 204 under the control of load power converter 206 as indicated by bidirectional arrow 244, (2) applying or removing power from energy storage device 210 under the control of battery power converter 212, and (3) by removing power from DC bus 204 by modulating the connection of dynamic brake resistor 214 to DC bus 204.

The structure disclosed in FIGS. 1-2 contains elements interchangeable with elements of the structures shown in the remaining FIGs.

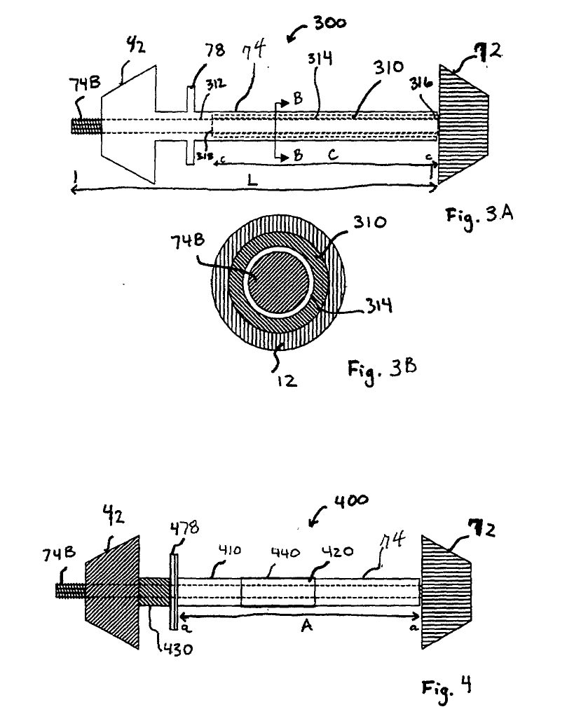

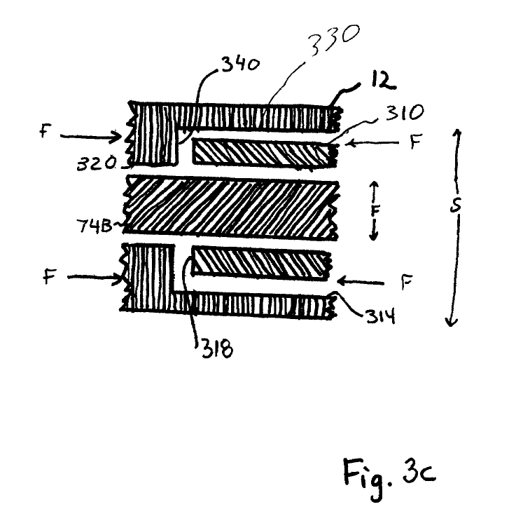

Referring now to FIGS. 3A and 3B, they illustrate a tie bolt clamp assembly 300 including shaft 74, compressor impeller 42, turbine wheel 72, tie bolt 74B, bearing rotor thrust disk 78 and clamp sleeve 310. Tie bolt 74B extends between turbine wheel 72 and compressor impeller 42. Tie bolt 74B is bound to turbine wheel 72 by a weld or other appropriate coupling. Bearing rotor thrust disk 78 is coupled to shaft 74 and preferably formed with shaft 74 as a unitary component. Alternatively, bearing rotor thrust disk 78 may be a separate component from shaft 74, but bound to shaft 74. Thrust disk 78 is constrained to rotate with shaft 74. Shaft 74 includes an interior surface having a first portion 312 and a second portion 314. The second portion 314 has an inner diameter. That inner diameter is larger than the inner diameter of first portion 314, and thereby forms an inset in shaft 74 extending in an axial direction along at least a portion of the length of shaft 74. The inset is sized and shaped to receive clamp sleeve 310.

Clamp sleeve 310 is axially supported between tie bolt 74B and shaft 74. Clamp sleeve 310 is formed as a sheath and is preferably annular shaped including an inner diameter and an outer diameter. The inner diameter and outer diameter are sized and shaped to cooperate with tie bolt 74B and the inset formed in shaft 74, respectively. Clamp sleeve 310 extends from first end 316, near turbine wheel 72, and terminates at second end 318, near thrust wheel 78. Although clamp sleeve 310 has a length C indicated by two-headed arrow line c-c, the length of clamp sleeve 310 may extend any length between compressor impeller 42 to turbine wheel 72.

In assembling tie bolt clamp assembly 300, preferably, tie bolt 74B is first contrained to turbien wheel 72. Then, additional components, including sleeve 310, rotor shaft 74, thrust wheel 78 (if it is not integral to rotor shaft 74), optionally a spacer (such as spacer 430 shown in FIG. 4), and finally compressor impeller 42, are slid onto tie bolt 74B. Then a nut (not shown) is screwed or otherwise fixed onto end of tie bolt 74B to compress all components mounted on tie bolt 74. That pressure imparts mechanical stability to compressor impeller 42 during high speed rotation.

Referring now to FIG. 3C, it illustrates second end 318 of the interior surface of shaft 74, shaft 74's first portion 320 and second portion 330, tie bolt 74B and clamp sleeve 310. First portion 320 has an inner diameter, indicated by two-headed arrow line F, which is smaller than the inner diameter, indicated by two-headed arrow line S, of second portion 330. First portion 320 is supported by tie bolt 74B and second portion 330 is supported by clamp sleeve 310. Shaft 74 includes shoulder 340 which provides a bearing surface to support end 318 of clamp sleeve 310 under compressive forces F acting in the axial direction.

Clamp sleeve 310 is made of a material with a low coefficient of thermal expansion, preferably lower than the coefficient of thermal expansion of shaft 74 or tie bolt 74B. Therefore, the length of clamp sleeve 310 changes more slowly with temperature than the length of either tie bolt 74B or clamp shaft 74, over operating temperatures of clamp sleeve assembly 300. The clamp sleeve material also may be thermally conductive. Exemplary materials for clamp sleeve 310 are titanium, titanium alloys, ceramic compositions or combinations thereof. Titanium has a coefficient of thermal expansion of about 5.2×10⁻⁶ inches/inches ° F. Steel has a coefficient of thermal expansion of about 8.4×10⁻⁶ inches/inches ° F. Alternatively, clamp sleeve 310 may include portions formed from a material with one coefficient of thermal expansion and other portions which are formed from a material with a desired or lower coefficient of thermal expansion. For example, steel may form a first portion and materials with less thermal sensitivity, such as titanium, titanium alloys, or ceramic compositions, may form a second portion of clamp sleeve 310.

During operation, compressor impeller 42 and tie bolt 74B rotate with turbine wheel 72. Tie bolt 74B presses thrust disk 78 and compressor shaft 74 toward the turbine wheel 72 such that an axial compression force develops on thrust disk 78, shaft 74 and clamp sleeve 310. The axial compression force secures assembly 300 together during operation. During rotation, tie bolt 74B and shaft 74, absorb thermal energy. Consequently, tie bolt 74B increases in temperature and stretches along its axial length (L) indicated by two headed arrow line 1-1, and shaft 74, acted upon by high RPM centrifugal forces, decreases from its non-operational length (C) indicated by two-headed arrow line c-c. Thus, during operation, as tie bolt 74 stretches and sleeve 74 extends in a radial direction, neither support the axial compression forces. However, clamp sleeve 310 minimally deforms, and therefore substantially maintains it axial length C indicated by two-headed arrow c-c, and thus retains the axial compressive load acting on thrust disk 78 and sleeve 74.

Referring now to FIG. 4, it illustrates an alternate embodiment showing tie bolt clamp assembly 400. Assembly 400 includes sleeve 74, compressor impeller 42, turbine wheel 72, tie bolt 74B, bearing rotor thrust disk 478, clamp sleeve 410, plate 420 and insert 430. The tie bolt 74B is coupled at one end to turbine wheel 72 and at a second end to compressor impeller 42 to form a rotatable assembly. Thrust disk 478, clamp sleeve 410 and insert 430 are supported on tie bolt 74B and are constrained to rotate with tiebolt 74B. Plate 420 is disposed on the exterior surface of clamp sleeve 410.

Clamp sleeve 410 preferably has an annular shape including a cylindrical surface at an inner diameter and a cylindrical surface at an outer diameter. The inner diameter is sized and shaped to cooperate with tie bolt 74B. The length A of clamp sleeve 410 extends from compressor impeller 42 to thrust disk 478, as indicated by two-headed arrow line a-a. Clamp sleeve 410 is formed from material having a relatively low coefficient of thermal expansion, such as those materials mentioned above.

During operation, the low coefficient of thermal expansion of the material of clamp sleeve 410 minimizes deformation of clamp sleeve 410, and thus clamp sleeve 410 substantially retains its length and shape. Since the length of clamp sleeve 410 remains substantially unchanged the axial compressive force exerted on thrust disk 478, clamp sleeve 410, and insert 430 remains substantially unchanged during operation. The aforementioned materials from which clamp sleeve 410 may be formed do not provide a preferred radial bearing surface facing the exterior surface of clamp sleeve 410. Insert or plate 420 forms a suitable radial bearing surface 440. Plate 420 may be formed to define surfaces coplanar with adjacent exterior surfaces of clamp sleeve 410. Plate 420 may define an annular shape with an outer cylindrical surface having the same diameter as the outer cylindrical surface of clamp sleeve 410. Plate 420 may be formed from a material that resists deformation, for example, plate material may be steel, steel alloys or other appropriate material. Plate 420 may be plated onto sleeve 410, welded to sleeve 410, or sintered to sleeve 410.

Obviously, numerous modifications and variations of the present invention are possible in light of the above teachings. It is therefore to be understood that within the scope of the appended claims, the invention may be practiced otherwise than as specifically described herein.

What is claimed is:

1. A tie bolt clamping apparatus, comprising:
a first component designed to rotate;
a second component designed to rotate;
a tie bolt coupled between said first component and said second component thereby forming a rotatable assembly in which said tie bolt, the first component, and the second component are constraint to rotate together;
a shaft supported on said tie bolt and disposed between said first component and said second component; and
wherein said tie bolt compresses said first shaft between said first component and said second component such that an axial compressive load on and first shaft is maintained during rotation of said rotatable assembly, thereby preventing mechanical instability.

2. The apparatus of claim 1, further comprising a sleeve disposed within said shaft.

3. The apparatus of claim 2 wherein said sleeve is not formed from steel.

4. The apparatus of claim 2 wherein said sleeve is formed at least in part from material having a coefficient of thermal expansion lower than the coefficient of thermal expansion of steel.

5. The apparatus of claim 2 wherein said shaft defines an inset surface formed on at least one of an interior surface and an exterior surface of said shaft.

6. The apparatus of claim 2 further including a plate coupled to said shaft.

7. The apparatus of claim 2 wherein said sleeve is formed from material which is thermally conductive.

8. The apparatus of claim 2, wherein said sleeve is formed from material selected from the group consisting of titanium, titanium alloys and ceramic compositions.

9. The apparatus of claim 1 further including a thrust wheel coupled to said shaft.

10. A tie bolt clamp apparatus, comprising:
a first component designed to rotate;
a second component designed to rotate;
a tie bolt coupled between said first component and said second component thereby forming a rotatable assembly in which the tie bolt, the first component, and the second component are constrained to rotate together about an axis defined by an elongated dimension of said tie bolt;
a shaft coupled to at least one of said first component and said second component and supported on said tie bolt, said shaft having an interior surface and an exterior surface, said interior surface forming an inset along at least a portion of a length of at least one of said interior surface and said exterior surface;
a clamp sleeve supported within said inset; and
wherein said tie bolt presses said first sleeve and said clamp sleeve against said first component during rotation such that an axial compressive load on said shaft is maintained.

11. The apparatus of claim 10, wherein said clamp sleeve is formed from material having a coefficient of thermal expansion which minimizes deformation of said clamp sleeve such that said axial compressive load is maintained.

12. The apparatus of claim 10, wherein said clamp sleeve is formed from material which is thermally conductive.

13. The apparatus of claim 10, wherein said clamp sleeve is formed from material selected from the group consisting of titanium, titanium alloys and ceramic compositions.

14. The apparatus of claim 10, wherein said shaft includes a thrust wheel.

15. The apparatus of claim 10, wherein said sleeve is formed from material having a low coefficient of thermal expansion.

16. The apparatus of claim 10, wherein said first component is a compressor element and said second component is a turbine element.

17. A method for maintaining a compressive load associated with a rotor shaft, comprising the steps of:
forming a rotational assembly including,
a first component designed to rotate,
a second component designed to rotate,
a tie bolt coupled between said first component and said second component in which said tie bolt, said first component, and the second component are constrained to rotate together along an axis defined by an elongated dimension of said tie bolt,
a shaft supported on said tie bolt, said shaft having at least one portion made of a material with a coefficient of thermal expansion which is lower than coefficients of thermal expansion of at least one of the material of said first component, said second component, and said tie bolt; and
rotating said assembly such that said tie bolt compresses said shaft and said first component against said second component such that an axial compressive load is applied to said shaft, whereby said at least one portion minimally deforms and thereby maintains said axial compressive load.

18. The method of claim 17, wherein an interior surface of said sleeve defines an inset, and said at least one portion forms a sheath disposed in said inset.

19. The method of claim 17, wherein said first component is a compressor element and said second component is a turbine element.
